(19) United States
(12) Patent Application Publication
(10) Pub. No.: US 2012/0179665 A1
(43) Pub. Date: Jul. 12, 2012

(54) HEALTH MONITORING SYSTEM

(75) Inventors: David W. Baarman, Fennville, MI (US); Richard B. Bylsma, Ada, MI (US)

(73) Assignee: ACCESS BUSINESS GROUP INTERNATIONAL LLC, Ada, MI (US)

(21) Appl. No.: 13/344,914

(22) Filed: Jan. 6, 2012

Related U.S. Application Data
(60) Provisional application No. 61/430,730, filed on Jan. 7, 2011.

(51) Int. Cl. G06F 17/30; G09B 19/00

(52) U.S. Cl. 707/709; 434/247; 434/127; 707/736; 707/E17.019; 707/E17.014

(57) ABSTRACT

A health monitoring system can include an intake tracker, an output tracker, a personal monitor, and a recommender. The health monitoring system can track food, exercise, and personal characteristics in order to provide health assessments and recommendations. The intake tracker can include a camera for capturing images of products. A data acquisition system can be used to acquire data about products that are photographed using a variety of methods. The data can be entered into a database with a picture of the product for later look-up. The data acquisition system can include a user-assisted segmentation method of an image to identify the product.

### SUMMARY OF THE INVENTION

The present invention provides a health monitoring system that can include an intake tracker, an output tracker, a personal monitor, a recommender, a product ID and nutrition database, a personal database, an input, and a display. The health monitoring system can track the food that a user eats, the exercise that a user does, and the user's personal characteristics in order to provide health assessments and recommendations. In one embodiment, the intake tracker provides comprehensive input tracking options. For example, the health monitoring system can be used to scan the barcode of a food product, take a picture of the food product packaging, take a picture of the food itself, or manually record the food item. The images can be matched with images in a database in order to associate nutritional or other information with the food being consumed.

The present invention also provides a method of plate content analysis including segmenting an image into food items, estimating the volume of each food item, and labeling each food item. The segmenting can be user-assisted or automated. Volume estimation can be performed with fixed values or with a method of using a known objects dimensions to scale the volume estimation appropriately.

In one embodiment, a health monitoring system includes an intake tracker for recording consumed products, an output tracker for recording activities, and a personal monitor for monitoring one or more personal characteristics. Some personal characteristics that can be monitored include energy expended, respiration, heart rate, sleep state, and body temperature. The health monitoring system can include a recommender for analyzing the recorded consumed products, the recorded activities, and the personal characteristics and in response, provide a health assessment or recommendation. The health monitoring system can include a caloric sensor and a body mass index sensor for increasing the resolution of the personal characteristic data. The intake tracker can include a camera for capturing images of products. Alternatively, a different type of input device can be used to track the input.

The health monitoring system can include a variety of different types of interfaces for communicating among the devices in the system. For example, a Bluetooth interface, a WiFi interface, an IR transceiver interface, or an Ethernet interface can be utilized to facilitate communication between devices in the health monitoring system.

In one embodiment, the health monitoring system can include an interface to a social network. Information from the intake tracker, output tracker, or the personal monitor can be shared in a personal health profile on the social network. Further, access to the personal health profile can be selectably restrictable. For example, some information can be shared publicly, some information can be shared with family, some information can be shared with friends, and some information may be shared with a combination of different categories of people. Access to the information can be decided at various levels. For example, access to an entire profile can be controlled or access to specific information within the profile can be selectably restricted or accessible.

In one embodiment, a method of monitoring health is provided that includes recording consumed products with an intake tracker, recording activities with an output tracker, monitoring one or more personal characteristics with a personal monitor, and analyzing the recorded consumed products, the recorded activities, and the personal characteristics. The method can include making a health assessment or a recommendation, or both. For example, the method of health monitoring may include recommending health supplements based on the data provided by the input tracker, output tracker, and personal monitor. The resolution of the data collected by the health monitoring method can be increased by using a body mass index sensor or a caloric sensor.

In one embodiment, a health monitoring system includes a camera for acquiring an image of a product and a data acquisition system for acquiring information about a product based on the image of the product. The product can include a food item, a food package, or a portion of a food package. In one embodiment, the data acquisition system includes a processor capable of optical character recognition of a nutritional label of the product. The nutritional information from the optical character recognition of the nutritional label can be associated with the product.

In an alternative embodiment, the data acquisition system includes a processor capable of image comparison. The processor can compare the image of the product to a database of known product images associated with nutritional information and determine whether the image of the product matches one of the known product images with nutritional information. In one embodiment, the data acquisition system includes the ability to do optical character recognition and image comparison. The optical character recognition of the nutritional label provides back-up data acquisition where the product cannot be located using the image comparison to the database of known product images associated with nutritional information. Further, where the product cannot be found in the database of known product images associated with nutritional information, the nutritional information from the optical character recognition of the nutritional label can be associated with the product in the database of known product images associated with nutritional information for later use during the image comparison process or during another data acquisition process.

In one embodiment, the data acquisition system includes a first web crawler and a second web crawler. The first web crawler is programmed to identify the product using the image of the product. The second web crawler programmed to identify nutritional information about the product using the product identity obtained by the first web crawler.

In one embodiment, the data acquisition system includes a processor for analyzing the image of the product to determine the identity of the product in the image. The colors in the image can be utilized to help determine the identity of the product. Once identified, a look-up table can be utilized to look-up nutrient components of the product. For example, macronutrient and micronutrient content can be looked up in a look-up table. Further, phytonutrient content of the product can be looked up in a look-up table based on the identity of the product. The nutrient component content can be a useful tool in determining a supplement recommendation.

In one embodiment, the method of health monitoring includes user-assisted segmenting of the image. The user-assisted segmenting of the image can include displaying the image of the product on a touch screen, applying a segmentation algorithm that segments the image by creating a boundary, and dragging the boundary on the touch screen across a food item in the image of the product in order to assist the segmentation algorithm by indicating an amount of acceptable variation in appearance for the food item so that the segmentation algorithm dynamically changes the region around the boundary.

The objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a block diagram of one embodiment of a health monitoring system.

FIG. 2 shows a flow diagram of one embodiment of an intake tracker.

FIG. 3 shows a method of image segmentation for an intake tracker.

FIG. 4 shows a method of volume estimation for an intake tracker.

FIG. 5 shows a method of labeling for an intake tracker.

FIG. 6 shows an additional step in a method of labeling for an intake tracker.

FIG. 7 shows sample color images of various plates of food.

FIG. 8 shows a picture of a plate of food and the same picture after automatic image segmentation.

FIG. 9 shows a method of user assisted image segmentation.

FIG. 10 shows sample images after user assisted image segmentation.

FIG. 11 shows volume estimates for food ion an image segmented plate.

FIG. 12 shows various methods of labeling food.

FIG. 13 shows new user, log in, and profile, screens of a mobile application for health monitoring

FIG. 14 shows search intake tracker screens of a mobile health monitoring application.

FIG. 15 shows barcode intake tracker screens of a mobile health monitoring application.

FIG. 16 shows output tracker screens of a mobile health monitoring application.

FIG. 17 shows additional output tracker screens of a mobile health monitoring application.

FIG. 18 shows recognized image intake tracker screens of a mobile health monitoring application.

FIG. 19 shows user defined image intake tracker screens of a mobile health monitoring application.

FIG. 20 shows image intake tracker screens of a mobile health monitoring application.

### DESCRIPTION OF THE CURRENT EMBODIMENTS

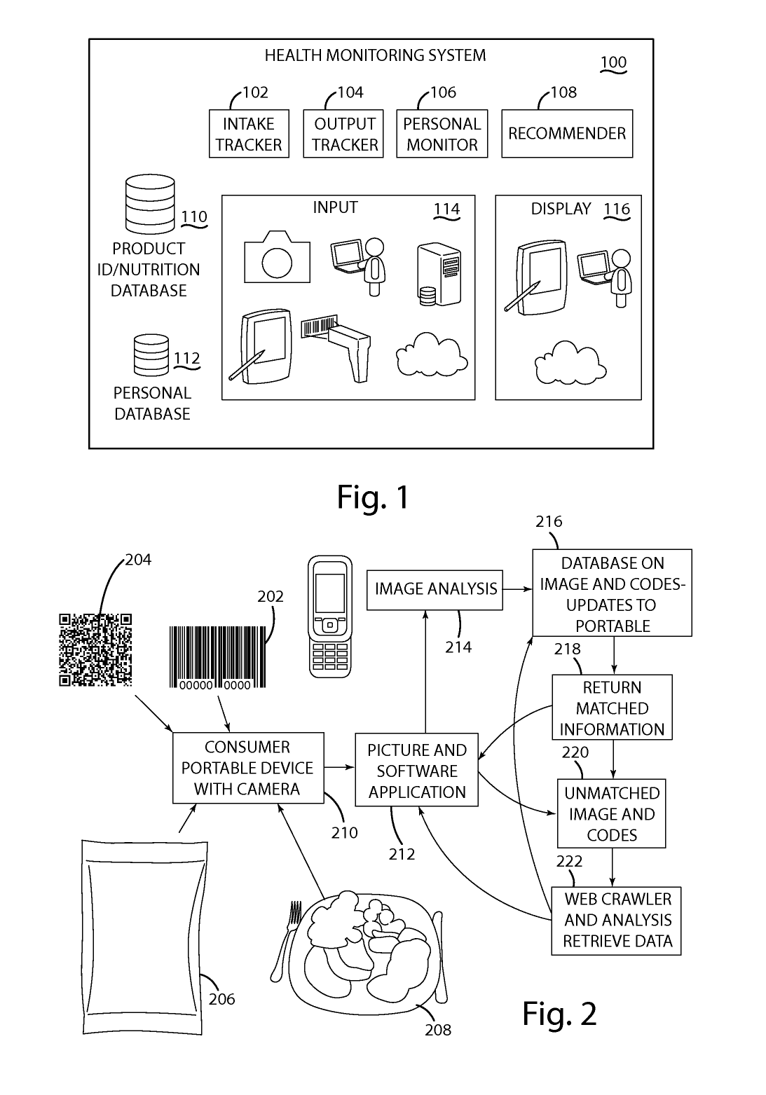

A block diagram of a health monitoring system in accordance with one embodiment of the present invention is shown in FIG. 1 and generally designated 100. The current embodiment of the health monitoring system includes an intake tracker 102, an output tracker 104, a personal monitor 106, a recommender 108, a product ID and nutrition database 110, a personal database 112, an input 114, and a display 116. The health monitoring system can track the food that a user eats, the exercise that a user does, and the user's personal characteristics in order to provide health assessments and recommendations. In one embodiment, the intake tracker provides comprehensive input tracking options. For example, the health monitoring system can be used to scan the barcode of a food product, take a picture of the food product packaging, take a picture of the food itself, or manually record. The image can be matched with images in a database in order to associate nutritional or other information with the food being consumed.

In general, the intake tracker 102, output tracker 104, personal monitor 106, and recommender 108 can be implemented in software are hardware. In the current embodiment, each are implemented in a mobile application that can run on a mobile smartphone. The intake tracker 102, output tracker 104, personal monitor 106, and recommender 108 can be separate modules that are part of one program, separate programs altogether, or just different parts of a single program. That is, separating the intake tracker 102, output tracker 104, personal monitor 106, and recommender 108 into separate modules is merely done for simplifying the description, and is not intended to be limit the configuration, arrangement, or combination of features that can be implemented in an embodiment of the health monitoring system.

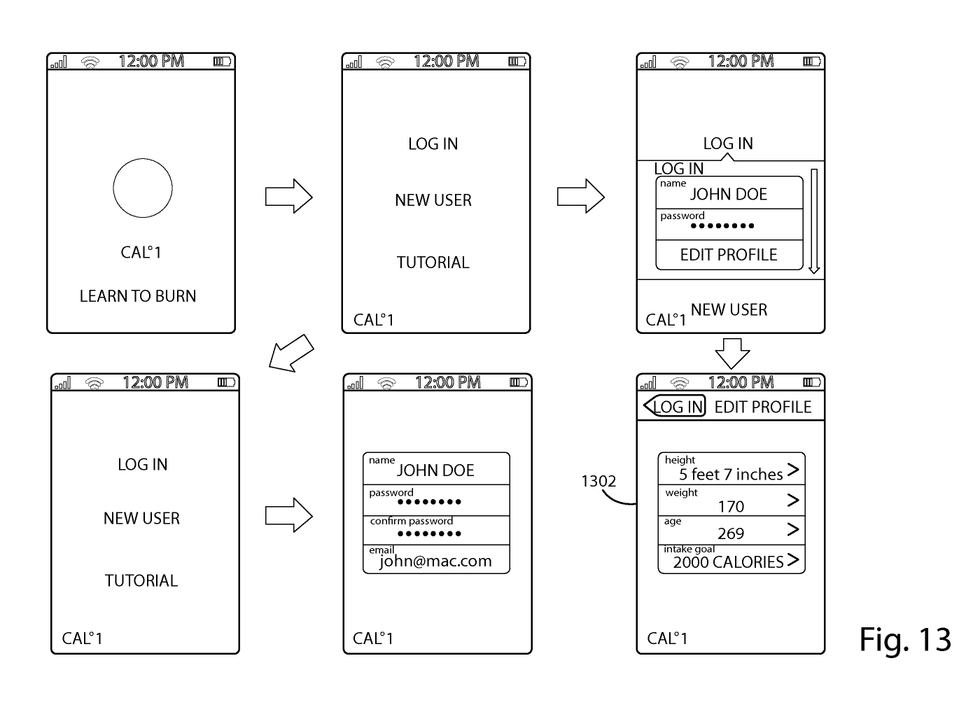

Various screenshots of one embodiment of an application running on a smartphone implementing an intake tracker 102, output tracker 104, personal monitor 106, and recommender 108 are illustrated in FIGS. 13-20. Some of the screenshots are merely representative and illustrate some of the various options that can be selected.

Referring to FIG. 13, several screenshots of the log in and new user registration process are shown. Screenshot 1302 illustrates the edit profile screen where a users height, weight, age and daily caloric goal are shown. The information stored in this profile can be utilized by the health monitoring system in conjunction with the intake tracker and output tracker in order to provide health assessments and recommendations. In alternative embodiments, the login/registration may be implemented differently and the profile may include additional or less information.

In the current embodiment, the intake tracker 102 can be used to assist a user in recording the products they consume. The output tracker 104 can be used to assist a user in recording their activities. The personal monitor 106 can include various sensor devices that can monitor body parameters such as energy expended, respiration, heart rate, sleep state, body temperature. The recommender 108 can assess a user's consumption, activities, and personal health data to provide recommendations. The product ID and nutrition database 110 includes a product identifier and data records that contain the nutritional information associated with the products. The personal database 112 can store a user's personal information such as weight, height, body mass index, nutritional content of all the food consumed by the user, the time at which the food was consumed, and health goals such as target weight and target body mass. The input 114 can provide input to any portion of the health monitoring system, such as the intake tracker 102, output tracker 104, personal monitor 106, or recommender 108. The display 116 can provide a display for any portion of the health monitoring system 100, such as the intake tracker 102, output tracker 104, personal monitor 106, or recommender 108.

The input 114 can be essentially any device that enables data to be input into the health monitoring system. For example, input 114 can include one or more of a variety of different input devices such as a bar code reader, a camera based device, a personal digital assistant, a web based data entry system, an electronic connection to another database, or a PC based application. The input devices may or may not be connected simultaneously, may be detachable, may communicate wirelessly with other components in the health monitoring system.

The display 116 can be essentially any device that enables data from the health monitoring system to be output. For example, display 116 can include one or more of a personal digital assistant, a PC application, a mobile device application, or a web based application. The display can provide audio, visual, haptic, or essentially any other type of output.

The recommender 108 can follow a user's eating habits by tracking fruits, vegetables, meats, dairy, grains and spotting specific food trends. Watching these trends allows the system to recommend diet and supplements to augment a user's eating habits. This system can provide these recommendations in real time. Further, if the recommender recommends a supplement, it may provide the ability to order the supplement directly over the internet or provide a list of stores that carry the supplement. The recommender 108 can work in conjunction with the intake monitor, output monitor, and personal monitor to monitor weight, food intake, nutrition, portions, food types and activity. Utilizing all of this information, the recommender can also help to recommend food proportions. For example, in order for a user to maintain a goal or hit a target the recommender may suggest eating a certain percentage of a certain food item or a certain percentage of a meal. This recommendation can be provided in text or audio to the user. In addition, the recommendation may be shown using a visual augmented reality overlay. For example, where the portions of the food shown in the camera are highlighted in a certain color if they should be eaten and highlighted in a different color if they should not be example.

Although the health monitoring system 100 of the current embodiment includes a product ID/Nutrition database 110 and a personal database 112, in alternative embodiments, the health monitoring system may include a single unified database or data warehouse that includes both databases or the records from both databases. Further, the databases can be located locally to the other components of the health monitoring system or remotely on a server that can be accessed via a network connection. The product ID/nutrition database may include multiple types of product identities or may include multiple databases for different types of products. For example, there may be one product ID/Nutrition database where the product IDs are pictures of food items, another where the product IDs are pictures of barcodes of food items, and another where the product IDs are pictures of food packages. In one embodiment, the product identifier may be the name of the product and there may be fields including one or more pictures of the food item, one or more barcodes of the food item, and one or more pictures of the food item packaging.

In use, the health monitoring system can generate a personal health profile. The personal health profile can include one or more tables, records, columns, rows, or other data items in one or more databases. The personal health profile can be a separate database itself. Or, in some embodiments, the personal health profile is merely an abstract concept useful for describing a collection of information within the health monitoring system. In one embodiment, the personal health profile is another name for the personal database 112 shown in FIG. 1 that includes personal nutritional and fitness information. The profile can include a variety of information such as nutritional supplements taken, caloric information of the food consumed, types of food consumed, food groups consumed, colors of foods consumed, personal weight, body mass index, height, calories burned, amount of time spent exercising, type of exercise, level of exercise, daily, weekly, yearly exercise and food trends, and weight of food consumed, to name some of the information that can be included in the personal health profile.

Various image analysis techniques can be applied to determine the identity of a product from an image of the product. For example, the color content, shape, size, pattern of the product can be used to help determine the identity of the product. The health monitoring system can include a database with assorted information associated with a variety of products. For example, a look-up table can include nutritional components, such as micronutrient and macronutrient content of various food products. The ability to monitor the amount of micronutrients or macronutrients consumed can be helpful to providing a useful health assessment. Further, the ability to track the amount and type of nutrient components being consumed can increase the effectiveness of supplement recommendations. In one embodiment, the amount of phytonutrients in a product can be determined from a look-up table, using the product identity as a key to the database.

Any component in the health monitoring system can contribute to the personal health profile, such as via the intake tracker, output tracker, personal monitor, recommender. Alternatively, in some embodiments, information may be directly added to the personal health profile via the input into the health monitoring system. Suffice it to say, the personal health profile can be developed in a variety of different ways. Information can be manually entered by the user. For example a user may use a scale to weigh themselves and enter their weight manually into the system with a keypad. Information can also be obtained from a sensor that is part of the health monitoring system. For example, some embodiments of the health monitoring system include a camera, which can be used to identify food by image analysis. Another example is a health monitoring system that includes a body mass index, glucose, metabolism or caloric sensor for adding resolution to intake tracker data. Information can also be downloaded from a third party tool, such as a smart exercise bike, oxygen analyzer, personal body monitor, scale, body mass index device, and essentially any other device with which the health monitoring system can interface. Third party devices can interface with the health monitoring system in a variety of ways. For example, the health monitoring system may include Bluetooth, WiFi, IR transceiver, Ethernet, or essentially any other interface by which a third party device can communicate with the health monitoring system. Any device that provides information to the health monitoring system may be included as an input 114 in the health monitoring system.

Body mass index sensor readings can be used to reconcile an expected body mass index in view of the recorded consumable product information and the recorded activity information. For example, a user may consume a certain amount of calories and perform a certain amount of activity that should result in an expected change in body mass index. By taking body mass index readings and comparing them to an expected body mass index for a given set of product consumption information and activity information, an assessment of certain intake actions and outtake actions can be assessed. For example, if a user eats carbohydrates and has an expected increase in body mass index, but when the body mass index reading is taken no actual change is recorded, the health monitoring system can account for that the recommender, perhaps by allowing additional carbohydrates in a recommendation.

The health monitoring system may interface with a social network. For example, in one embodiment the health monitoring system may be programmed to share a summary of a user's personal health profile on a social network. Using the summary, general progress can be compared in relative terms to other users without allowing other users to access the full personal health profile. In some embodiments, friends can share specific information in their personal health profile so friends can compare and contrast their personal health profiles to promote good health and foster competition.

Although the current embodiment of the health monitoring system is intended for use by individuals, it may be useful in clinical situations for aiding medical personnel in monitoring a patient's health. For example, in one embodiment the health monitoring system, the patient can carry a wireless-enabled personal digital assistant that can communicate information to a health care provider who maintains the patient's personal health profile.

The health monitoring system can be implemented in a portable device that can be carried in a pocket, purse or belt holster. For example, the health monitoring system can be implemented as a mobile application on a smartphone, personal digital assistant, or a dedicated health monitoring mobile device. Although the current embodiment of the health monitoring system is implemented on a portable mobile telephone, alternative embodiments can be implemented in a variety of different devices of varying sizes and shapes. For example, the health monitoring system can be implemented on a tablet, laptop computer, or a desktop computer.

In some embodiments, the health monitoring system can be distributed over multiple devices. For example, a portion of the health monitoring system may be implemented on a mobile device and another portion may be implemented on a desktop computer. Another example is a Product ID/Nutrition database on a remote server that can be accessed through a network by a device that includes a software application with an intake tracker, output tracker, personal monitor, and recommender.

As mentioned above, a health monitoring system in accordance with an embodiment of the present invention may include an intake tracker for tracking the intake of a user. Using the information tracked by the intake tracker, the health monitoring system can provide recommendations and health assessments. In combination with the information gathered from a personal monitor, output tracker, or other source, the health monitoring system may be able to provide more detailed recommendations and health assessments. Some embodiments of an intake tracker and methods for tracking intake will be described in more detail below.

The intake tracker of the current embodiment can track food a user consumes by any of the following methods: manually entering information about the food into the system, taking a picture of the food, or taking a picture of the food packaging. If a picture was taken, after some image analysis, the food item can be looked up in a database. If the name of the food was entered manually, nutritional information about the food item could be looked up or entered manually. In alternative embodiments, the intake tracker may include a different combination of methods for tracking food a user consumes. In other embodiments, the intake tracker may include additional or fewer methods of tracking intake. In one embodiment, the intake tracker may include only one method for tracking food a user consumes.

Although the intake tracker of the current embodiment can be used to track almost any item, the intake tracker is described in connection with tracking food items in particular. It should be understood that a food item includes essentially any item that can be consumed for nourishment, medicinal purposes, or pleasure including but not limited to solid food, liquid food, medicine and nutritional supplements. To be clear, it is intended that liquid, such as water, pop, or other beverages be included within the definition of food.

A method of tracking intake in accordance with an embodiment of the present invention is described generally in connection with FIG. 2. The illustrated method includes photographing a barcode 202, a 2d barcode 204, a food package 206, or a plate of food 208 with a camera in a portable device 210. The picture can be communicated to a local or remote software application 212 for image analysis 214. The picture can be compared to an appropriate database of images or barcodes 216. If a match is found, that information can be returned to the portable device 218. Any unmatched images or codes 220 can be fed to a web crawler and analyzed to retrieve data 222 that can be used to look up the food in an appropriate database 216.

The method of tracking intake may vary depending on the image captured by the intake tracker. In the current embodiment, the image can be a picture of essentially any product. For example, the picture can be of a food item, food packaging, or a portion of the food packaging. Information about the food item may be readily available by way of a label with appropriate nutritional information or by identifying the food item and looking up the information in a database.

When a picture of a food item is taken, the intake tracker can analyze the image to determine a variety of information about the food item such as the type and amount of food. One embodiment of the image analysis generally includes segmenting the image into different food items, estimating the volume of food present for each food item, and labeling each food item. After this image analysis, the system can automatically look up the nutritional information for each food item in a database, shortening the intake tracking process. The nutritional information may be adjusted based on the amount of food in the picture, the amount of food actually consumed, or a variety of other factors. In this way food can be recognized and nutritional data, such as caloric and fat information can be accurately recorded in a personal health profile.

Referring to FIG. 7, six images of a wide range of plate content combinations, including rice/meat/vegetables, hummus/crackers/vegetables, soups, pastas, desserts, are shown. The images were collected using a smartphone and are representative of images that an intake tracker can process. Below, the current embodiment of image analysis including image segmentation, volume estimation, and labeling is described in connection with some of the food images shown in FIG. 7, and generally designated 700. This process may be referred to as plate content analysis.

Image segmentation generally refers to segmentation or identification of objects within an image. Segmenting an image into the various food items can provide an area estimate for each food item. When combined with a depth estimate the volume of each food item can be estimated. In addition, segmenting the image into the various food items simplifies and clarifies labeling, which when combined with the volume estimation enables the system to track specific information such as the amount of calories of each food item in the image.

In some embodiments, the image segmentation may be fully automatic by using techniques such as clustering, connected components analysis, or other image segmentation techniques. Each of these techniques can involve some level of threshold tuning in order to optimize performance.

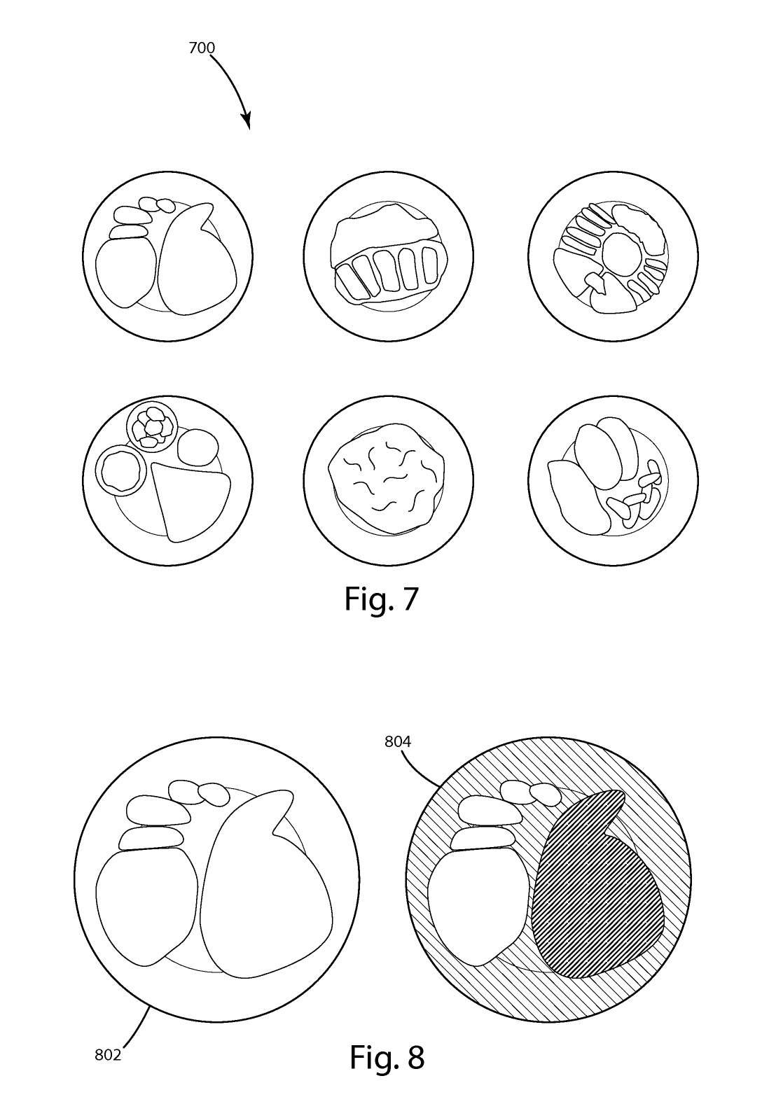

In some embodiments, clustering and connected components analysis are less effective because of the narrow threshold values required to distinguish the food item from the background. Thus, food items may be segmented incorrectly. Even uniformly colored food items may be broken into multiple segments due to glare or shadow. For example, referring to FIG. 8, the image on the left 802 shows a plate of food with pasta, carrots, and steak before image segmentation and the image on the right 804 shows the plate after image segmentation. As can be seen in the picture, the steak is segmented into dozens of pieces due to its relatively high variation in color and brightness. The plate, which is a uniform color is also broken into multiple segments due to shadows and glare.

In order to address some of the issues with fully automated segmentation solutions, a user-assisted approach may be implemented. In one embodiment, the method of image segmentation includes dragging a line or boundary over each food item in the image in order to see the segmentation process. Through this action, the user can implicitly indicate how much variation in appearance is acceptable for a particular food item, after which an automated segmentation algorithm can dynamically expand the region around the line. For example, one automated segmentation algorithm starts with a boundary defining a segment. If neighboring pixel are within a threshold of the pixels already included in the segment then that pixel can be included in the segment. This process can be repeated recursively for the neighbors of each pixel in the segment. In this way, because the neighbors of each pixel are compared, increasing the changing the boundary changes the acceptable amount of variation in the segment. There are many variations of segmentation algorithms that use various thresholds and various definitions of neighbor pixels. Essentially any automated image segmentation algorithm can work with this process because the user-assisted boundary change provides a meaningful input to the semi-dynamic segmentation algorithm.

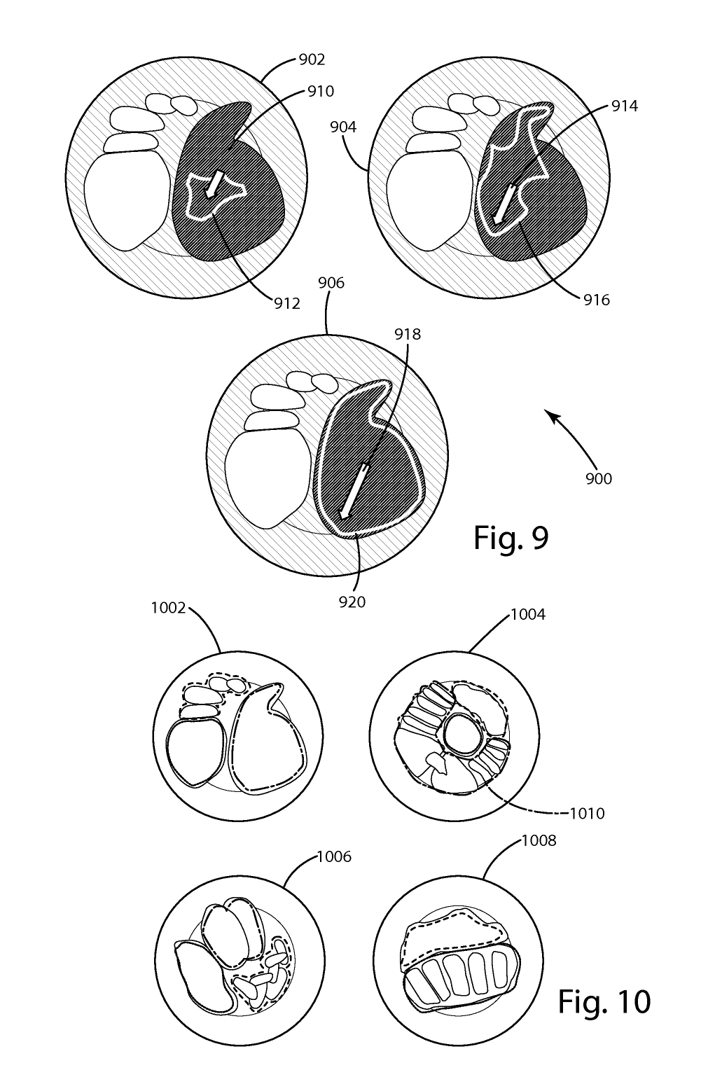

An example of one user-assisted segmentation process is illustrated in FIG. 9, and generally designated 900. Each image in FIG. 9 illustrates how the segmentation changes in real time as a user drags an arrow over the food. In the first picture 902, the arrow 910 is short and the resulting segment 912 does not cover the entire steak. In the second picture 904, the arrow 914 is dragged a bit further and the resulting segment 916 expands to cover additional area. In the third picture 906, the arrow 918 is dragged even further and the resulting segment 920 encompasses the entire steak. The segment 920 can be used to estimate the area of the steak. Additional examples of segmented images utilizing this technique are shown in FIG. 10. There are four images 1002, 1004, 1006, 1008 each showing how different food items are segmented utilizing the user-assisted segmentation method described above.

The user assisted approach can allow a user to group together several items that might have a significantly different appearance. For example, in the automatic segmentation result shown FIG. 8, the dark green vegetable at the top of the plate is segmented differently from the rest of the group of mixed vegetables. For simplicity and efficiency, a user may consider the mixed vegetables to be a single food item same and can group them together using the assisted-segmentation process. An example of this is shown in FIG. 10. The vegetables 1010 in the top right photo 1004 of FIG. 10 are all grouped together as a single item, limiting the amount of user input during the labeling stage.

Once a food item has been segmented in the image, the volume of that food item can be estimated. Volume estimation can be helpful in determining caloric content, weight, serving size and other characteristics about the food item.

In one embodiment, a volume estimate may be made using a food image and estimating a pixel unit volume, counting the number of pixels in the food item, and multiplying the number of pixels in the food item times the pixel unit volume estimation. Pixel unit volume can be estimated in a number of different ways. A pixel unit volume can be calculated by determining the area of a pixel and multiplying that by a depth value. There are a number of different ways to determine the area of a pixel and a number of ways to select a depth value.

The area of a pixel can be found by multiplying the length of the pixel times the width of the pixel. In some embodiments, including the current one, pixels have the same length and width. Accordingly, the area of a pixel can be calculated by either calculating the pixel width or the pixel height. Pixel width can be determined by dividing the actual width of the image by the image width in pixels. That is, pixel width can be determined by the following formula:

pixel width=image width (inches)/image width (pixels)

Determining the actual width (or height) of the image can be done in a number of different ways. In one embodiment, the width can be estimated by a user. For example, the user may know they are eating off of a 12 inch diameter plate and can easily estimate the width of the image using that knowledge as a reference point. In another embodiment, image width can be calculated directly based on limited knowledge of the camera lens if users are instructed to position the camera at a particular height above the plate. That is, depending on the lens in the camera, the distance from the object, and potentially other factors, the width in inches (or some other unit of distance) of a pixel, and therefore the area of a pixel can vary. To put it another way, a pixel in a picture snapped from five feet away from a food item may have a different width in inches than a pixel in a picture snapped from ten feet away from the food item with the same lens. However, by instructing the user to always take pictures from a particular distance away from the food, the pixel width can be presumed or calculated, accounting for the type of lens. In the current embodiment, the image width is fixed at 16 inches.

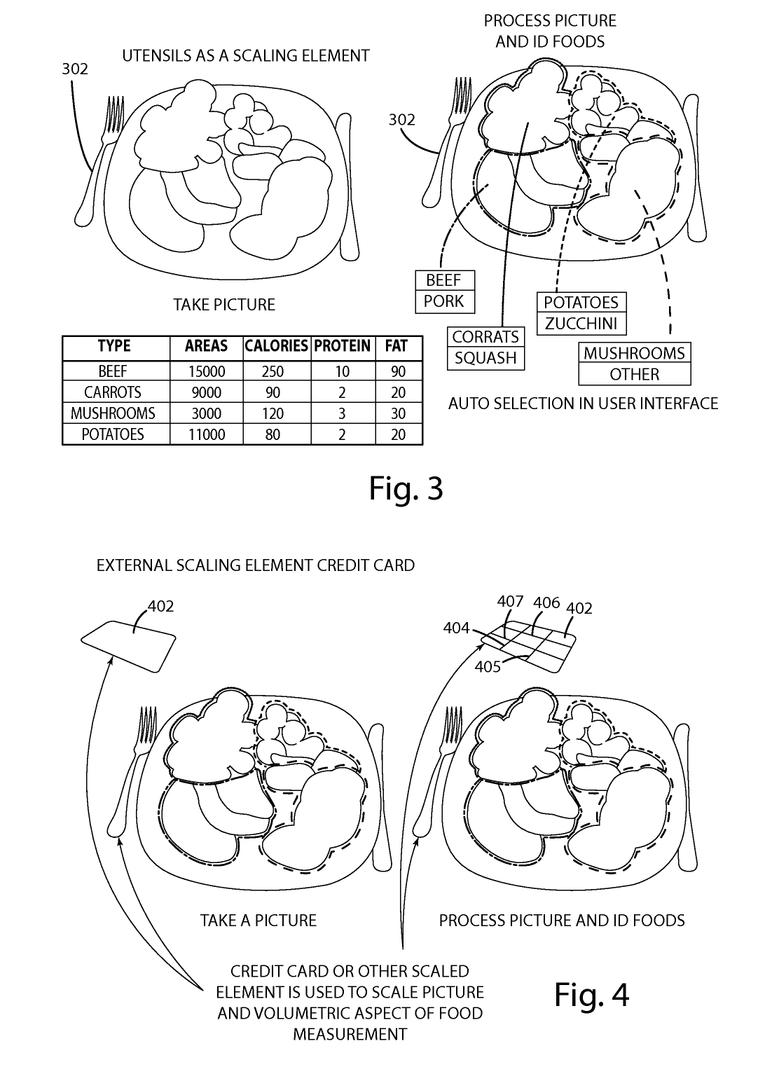

In yet another embodiment, an object with a known size may be included in the picture and used as a scaling element. For example, as shown in FIG. 3, one or more utensils 302 may be included in the picture. The utensil has a known length and width and therefore can be used to determine the width of a pixel regardless of the distance the picture is taken. In one embodiment, during segmentation, the utensil can be segmented. The number of pixels in the utensils segment can be counted and used to calculate the area of a single pixel by dividing the known surface area in sq. inches by the number of pixels counted in the segment. If the length or width of the object is known, the number of pixels corresponding to the length or width of the object can be counted and used to calculate the length or width of a pixel by dividing the known length or width in inches by the number of pixels along the length or width of the object. FIG. 4 illustrates another embodiment of scaling. In FIG. 4, instead of the picture just happening to include an object of known dimensions, the user purposely places an object with known dimensions before taking the picture. In the illustrated embodiment, a credit card 402 is included in the picture. As part of the scaling process, the user can draw lines 404-407 on the object. The dimension of a pixel can be determined based on the measured length or width of the credit card in pixels and the known length or width of the credit card in inches (or another unit of measurement). By dividing the actual, known, length or width of the credit card by the respective measured length or width of the credit card in pixels, the unit value of the length or width of a pixel can be determined.

In the embodiment shown in FIG. 4, the user may be prompted to draw lines designating the width of the object at multiple locations 406, 407 and lines designating the length of the object at multiple locations 404, 405. By drawing multiple lines the width of a pixel can be determined more accurately because the perspective can reduced or eliminated.

Once the pixel width is determined, the pixel area for a square pixel can be calculated by multiplying the pixel width times itself. That is, pixel area can be determined by the following formula:

pixel area=pixel width (inches)*pixel width (inches)

In some embodiments, pixel length may be determined in a similar fashion as to that described above in connection with pixel width. In those embodiments, pixel area may be calculated by multiplying pixel width times pixel length. That is, pixel area can be determined by the following formula:

pixel area=pixel width (inches)*pixel length (inches)

Multiplying the estimated pixel unit area times a depth can provide an estimated pixel unit volume. The depth value can be selected in a number of different ways. In some embodiment, the depth value is set to a particular value, for example in the current embodiment the depth is fixed at one half inch. In some embodiments, setting a static value for depth provides satisfactory volume estimation. In another embodiment, the user may be prompted to provide an average food depth for each food item. In another embodiment, the depth may be set to the average food depth of a food item that can be looked up in a database. For example, once a user has labeled a food item as a banana, the system may look up the average food depth for a banana in a database and use that value for the volume estimation. In yet another embodiment, the food depth for a particular food item may be related to another, known, dimension of the food item. This relationship may be known or looked up in a database. For example, an orange is generally spherical, so its depth may generally be equal to its width and height. To be clear, width and height in this situation refer to the width and height in inches of the orange (not the width and height of a pixel). The width or height of a food object can be calculated once the width (or length) in inches of a pixel is known by counting how many pixels wide or long the segmented food item is and calculating the length or width of the food item based on the number of pixels. In some embodiments, the depth estimation may be a matrix of depth values instead of an average depth value. For example, for an egg prepared sunny side up, the depth of the egg yolk and the depth of the egg white may have different depths. The depths could be user selected, average depth values could be used, or the depth values could be based on a relationship with a known dimension of the food item. Once a depth value is selected or determined, the pixel unit volume or volumes for a food item can be calculated by multiplying the pixel unit are times the depth value. That is, pixel volume for each pixel can be determined by the following formula:

pixel volume=pixel area*depth

Utilizing this method, the total volume for a segmented food item can be calculated by multiplying the calculated pixel volume by the number of pixels in the image that correspond to the food item. In embodiments where multiple pixel volumes were calculated, such as the sunny side egg example, the total volume for a first portion of the segmented item can be calculated by multiplying the calculated pixel volume by the number of pixels in the image that correspond to the first portion of the segmented item. Then, the total volume for a second portion of the segmented item can be calculated by multiplying the calculated pixel volume by the number of pixels in the image that correspond to the second portion of the segmented item. The different portions of the food item may be identified by the user, may be automatically identified during the labeling process based on thresholding, or any other suitable way of identifying the different portions.

There are other ways of estimating volume. In one embodiment, a depth estimate may be made by creating a synthetic stereo view with images taken from slightly different camera positions. The depth estimate in conjunction with the area estimate provided during image segmentation can provide a volume estimate. For example, in one embodiment, the depth estimate is multiplied by the area estimate to obtain a volume estimate. In alternative embodiments, additional factors may be considered and used to alter the estimate. In another embodiment, a light source can be used to project a light pattern on to the object of interest. The image taken with the camera can be analyzed in order to compute depth information of the food plate and subsequently infer food volume. In another embodiment, a 3-D image can be obtained using a Time-of-Flight camera which is able to capture 3-D images, food volumes can be inferred from the 3-D images.

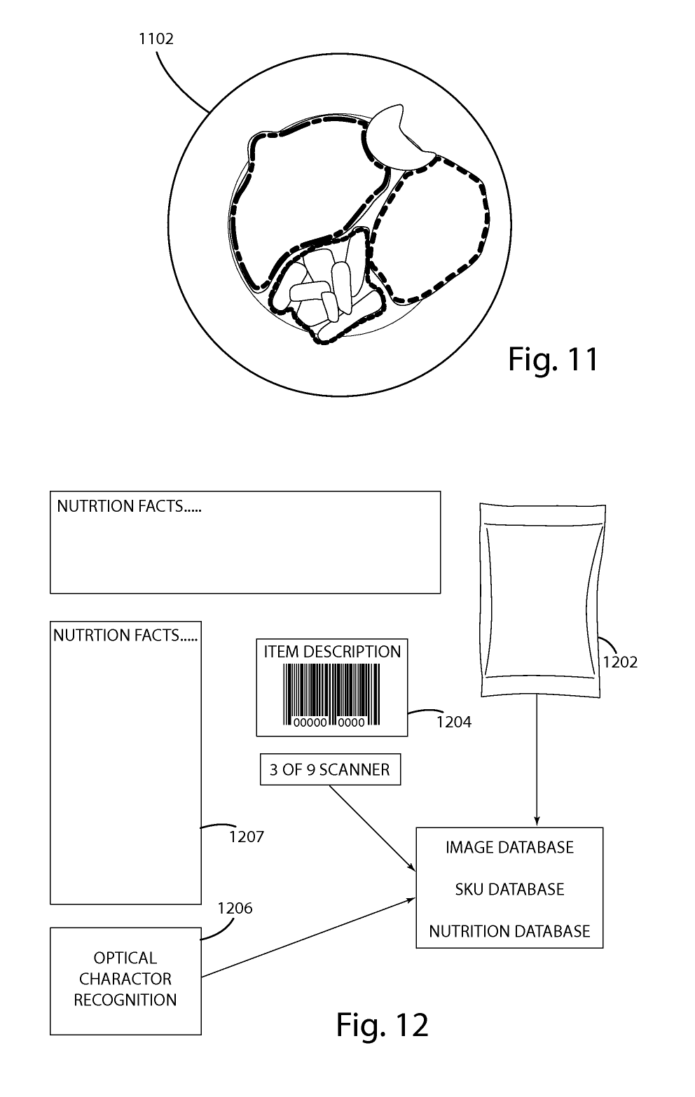

Referring to FIG. 11 an image 1102 of a complete plate content analysis is shown. There are three segments identified on the plate: meat, vegetables, and rice. The labels can be color coded with the segmentation border for easy identification. The estimated weight and calories of each segment can be provided. Please note that the values shown in the illustrated embodiment are notional.

Plate content analysis may include labeling and assigning nutritional information to the segmented food items. In one embodiment, the health monitoring system includes a database of common foods and their associated nutritional information. In one embodiment, users can select an appropriate label for a given food item by drilling down in a hierarchical menu, for example “vegetable>beans>green beans”. The nutritional information can be logged, and the caloric content calculated. In some embodiments, the caloric content may be based on a volume estimation. A variety of reports can be generated about the caloric and nutrient content for the meal or for a collection of meals.

The various embodiments of the method of plate content analysis described above can be executed in a mobile web application as a stand alone application or as part of a larger health monitoring system. User-assisted plate content analysis can be implemented on a smartphone using a touch screen interface. By quickly swiping over the food items they can be semi-automatically segmented from the image. This user assisted approach may use less user input that a fully automated plate content analysis system, because a fully automated system may produce errors that the user has to clean up.

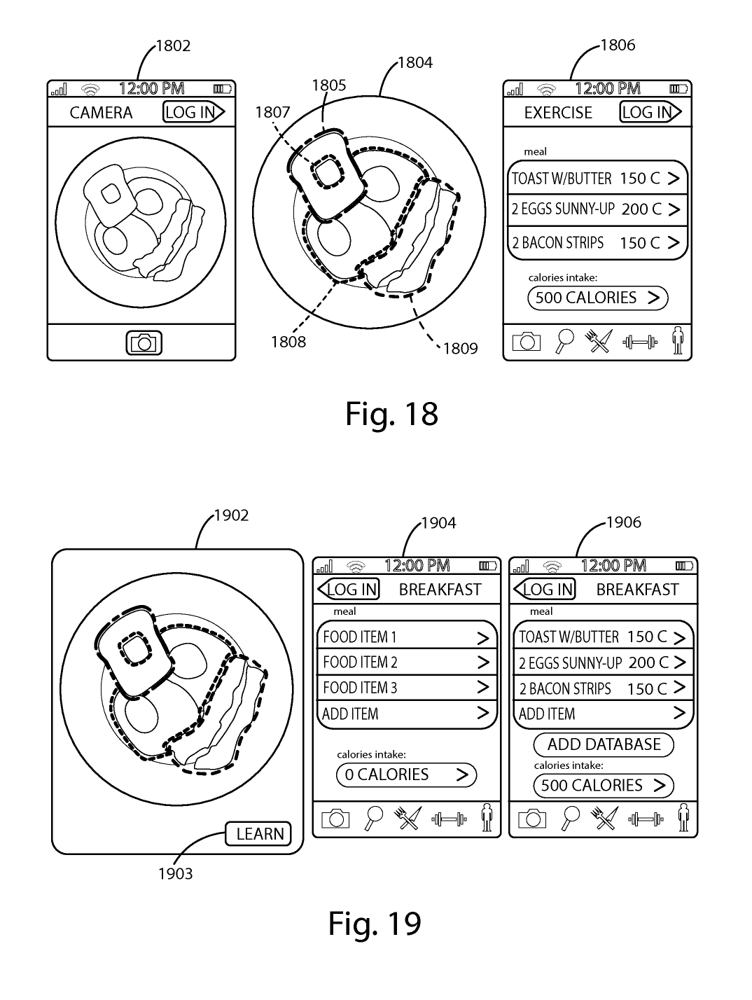

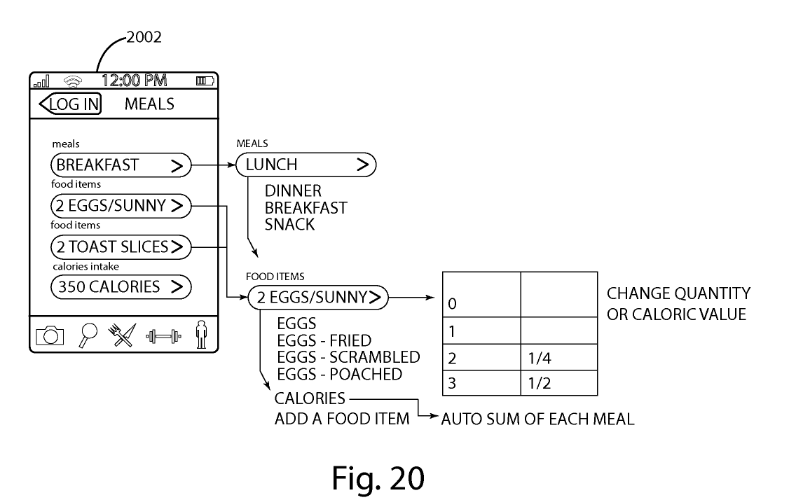

Some representative screenshots of a mobile application capable of plate content analysis are shown in FIGS. 18-20. Referring to FIG. 18, screen 1802 shows an exemplary screenshot of a mobile application ready to snap a picture of a plate of food. Screen 1804 shows a picture after image analysis is complete and all items were recognized by the system. The toast 1805 , butter 1807, eggs 1808, and bacon 1809 are all segmented and labeled. Screen 1806 lists each of the items that was recognized by the image analysis and the nutritional information associated with those items. The screen 1806 also lists the total tally of calories on the plate. Each of the values can be customizable and any changes the user makes can automatically be reflected in the total caloric tally. Referring to FIG. 19, screen 1902 shows a picture after image analysis is complete, all of the items were not recognized, and a “LEARN” button 1903 is present on the screen. After selecting the learn button the user is presented with screen 1904, which allows the user to select the food item to learn. In the current embodiment, this brings the user back to the segmented image where the user can use their finger to select the food item to be learned. Once selected, the user can select the learn button again and returns to screen 1904. On screen 1904 food item 1 will be highlighted with the ability to select the item and enter the name and new values. The process can be repeated for each unrecognized food item. An exemplary screen 2002 for entering the name and values is shown in FIG. 20. Although the process in the current embodiment is manual, in alternative embodiments, the process for populating data for unrecognized items may be assisted by the use of a camera or web crawling. Once the desired food items have been entered an “add to database” button may be selected on screen 1906 to store these new items in the database.

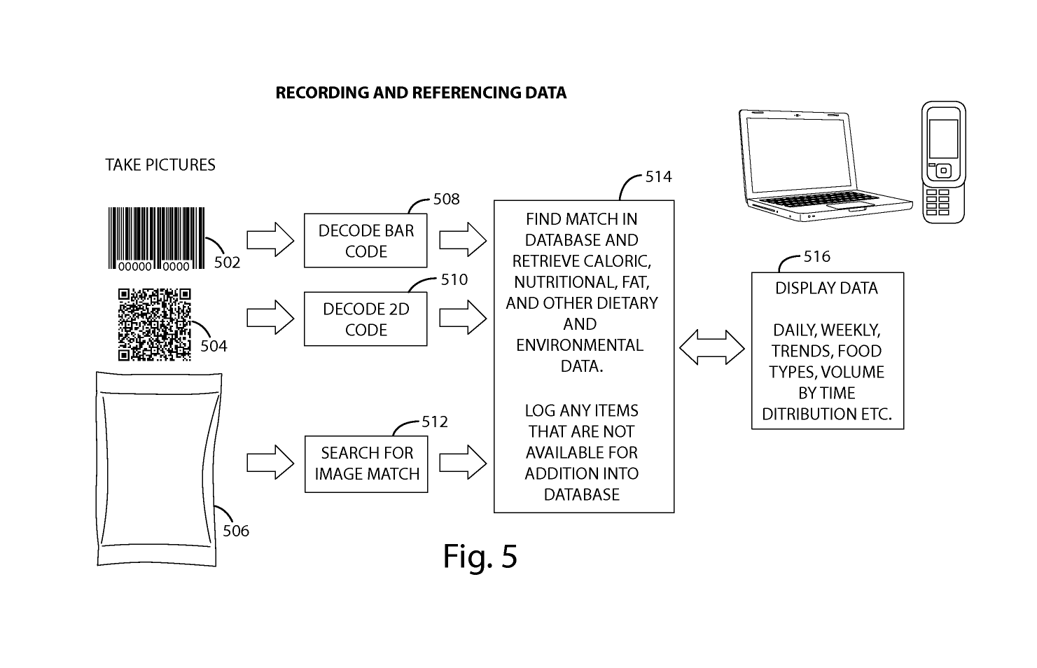

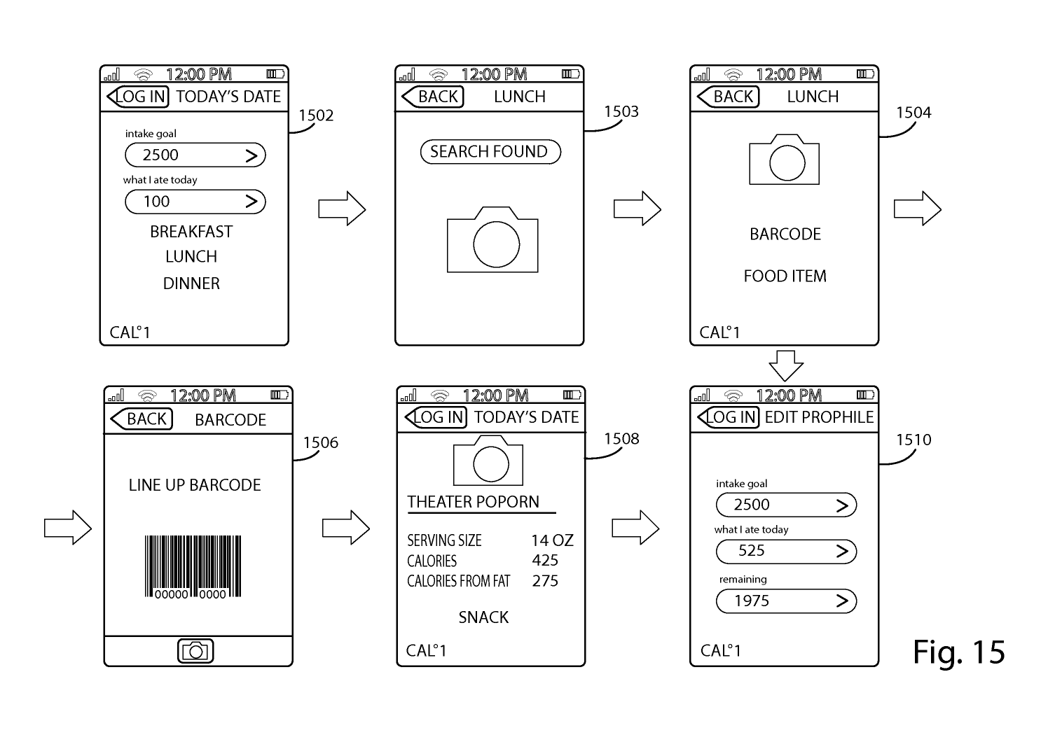

In addition to taking a picture of the actual food, the health monitoring system of the current embodiment can also take pictures of food packaging. Referring to FIG. 5, a picture can be taken of a barcode 502, a 2d barcode 504, or food packaging 506. If the image captured is a barcode 502, 2d barcode 504, or some other type of identifying code on the food package, then the intake tracker can decode the barcode 508 or decode 2d code 510, find a match in a database, and retrieve caloric, nutritional, fat, and other dietary and environmental data 514. That is, the intake tracker can analyze the image to identify the code and look up the food item in an appropriate database. The database can be located on the same device as the intake tracker or be accessible over a network on a remote server. An example of an embodiment with this feature is illustrated in the mobile application screens shown in FIG. 15. On the first screen 1502, the user selects a meal. On the next screen 1503, the user can either manually enter the name of a food item or can select the option to take a picture of the food item. The next screen 1504, allows the user to select whether the picture will be of the food item or of the barcode on the food packaging. The next screen 1506, illustrates the interface for taking a picture of the barcode of a food item. The next screen 1508, shows information retrieved by the system based on the barcode. In the current embodiment, the name, serving size, calories, and calories from fat are shown. In alternative embodiments, additional, less, or no information may be presented to the user at this stage. The last screen 1510, shows the user's daily caloric goal, the total number of calories eaten including the food item just entered into the system and any previously entered food items, and the remaining number of calories recommended or allowed for the day. In alternative embodiments, the user may be prompted to identify how much of the food item was consumed. In this way, a food item that is not consumed in its entirety can be accurately entered into the system.

Referring back to FIG. 5, if no match can be found in the database those items can be logged for addition into the database 514. The found data can be displayed to the user in its raw form or in the form of a report 516. There are a wide variety of reports that can be provided to the user. A daily report, weekly report, trend report, report organized by food type, a report organized by volume and time, and distribution.

If the picture is of the packaging, a database of package images can be searched in an attempt to match the pictured package with a known package in the database 512. Once a match is found, the caloric, nutritional, fat, and other dietary and environmental data can be retrieved 514. If a similar package image cannot be found, then the food item can be logged for addition into the database once it is labeled 514.

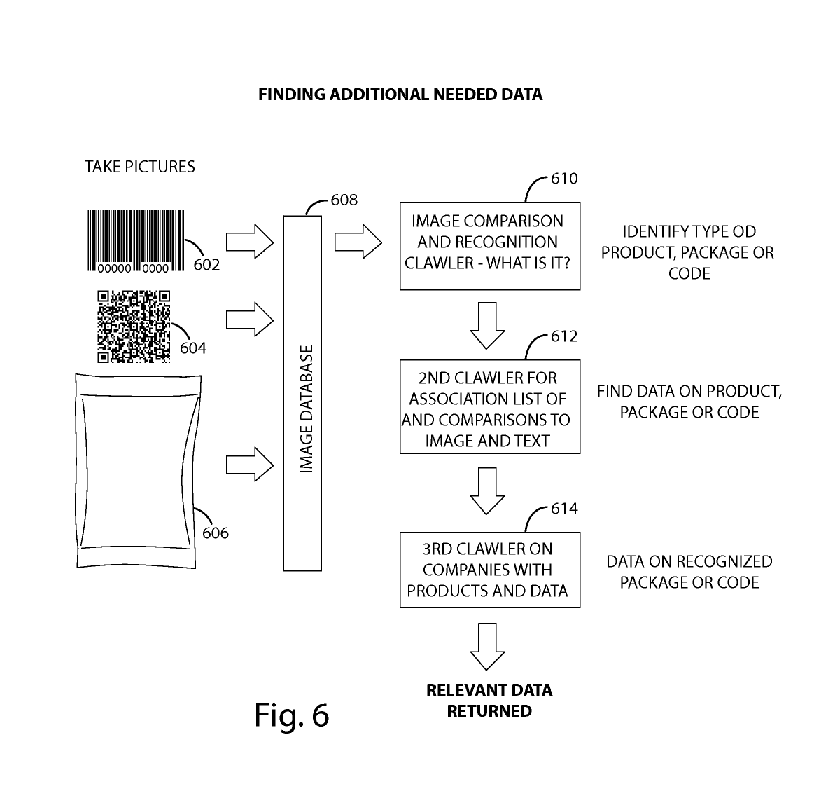

One method of finding additional data to label the food item is illustrated in FIG. 6. If a barcode 602, 2d barcode 604, or package image 606 cannot be located in a database, they can be added to an image database 608. In order to make addition to the database useful, it is helpful to identify the type of product, package or code. This can be done by doing an image comparison and recognition crawler to determine a label for the item 610. Alternatively, the user may manually enter a label for the item. Additional data can be located by finding data on the product, package or code, for example by utilizing optical character recognition. This information can be run through a second web crawler for association list of and comparisons to image and text 612. Data on recognized package or code can be determined by a third web crawler on companies with products and data 614. Once this process is complete the relevant data can be returned to the user and/or added to the database as a description of the image that could not be found in the database.

Referring to FIG. 12, one embodiment of a method of adding food items to a database is illustrated. If a food item is not found in the database, the user may desire to add the item to the database so that the next time that item is consumed it will be recognized by the system. The system may support manual entry of the food item and associated data into the database. In addition, the system may provide an automated or semi-automated method of adding a food item to the database. If an image of the product was used to search for the food item in the image database but no matches were found, then that image can be used to add the food item to the database. If an image of the product was not used to search for the food item, one can be taken and a search can be performed. If no match is found, then that picture can be utilized for the new entry 1202. If the food item has a barcode and it was not previously scanned, a picture of the barcode can be taken and added to the database in association with the picture of the food 1204. If the food item includes nutritional information 1207, for example nutritional information is sometimes included on the packaging, then a picture of that nutritional information can be taken and optical character recognition 1206 can be utilized to populate the database with nutritional information about the new food item entry. In an alternative embodiment, the image of the nutritional information may be entered into the database and may be used for searching.

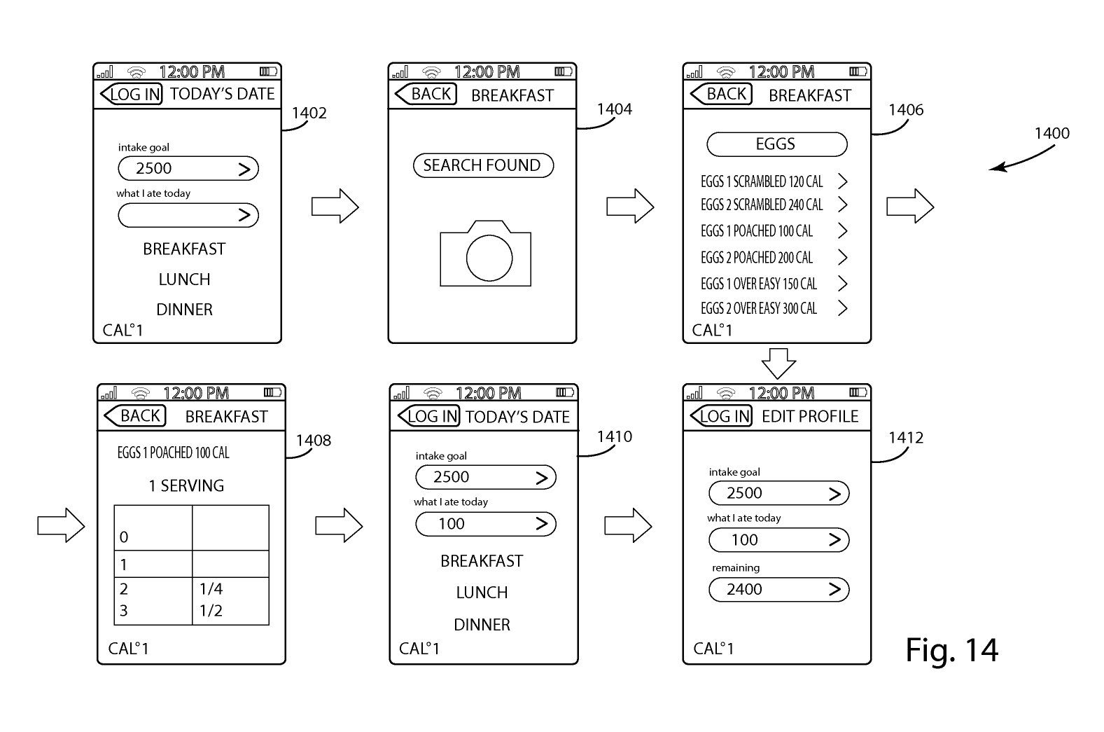

A user can manually enter a food item into the system. An example of a method of manually entering a food item into the health monitoring system is illustrated in FIG. 14, and generally designated 1400. The method can include selecting an intake goal for the day, viewing the food items previously eaten for the day, and selecting a meal to record a food item 1402, entering the name of a food item into a search field 1404, displaying the results of the search and selecting the appropriate food item from the search results 1406, entering the serving size of the food item 1408, displaying the intake goal for the day, caloric intake for the day, and the remaining caloric intake for the day 1410, 1412.

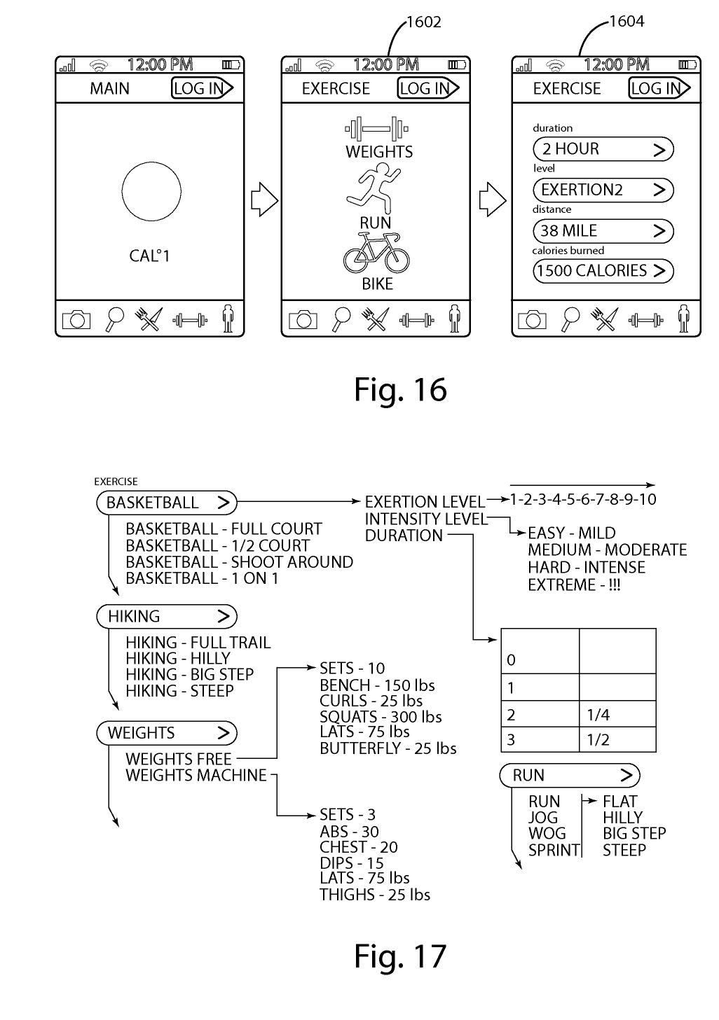

Referring to FIGS. 16 and 17, two annotated screenshots from one embodiment of a mobile application including an output tracker are shown. The output tracker provides a simple easy to use interface for a user to manually record exercise activities. In alternative embodiments, exercise equipment may automatically communicate with the output tracker to provide real time, accurate, exercise information. In addition, exercise equipment may provide additional information, such as heart rate, oxygen level, pulse, or other biometric data, which can be utilized anywhere within the health monitoring system. In the current embodiment, the mobile application provides a screen 1602 where the user can select the type of exercise. In the current embodiment, this includes, weights, riding, swimming, running, hiking, and walking. After selecting the type of activity, the user is prompted to provide some input about the activity. For example, in the current embodiment, as shown in screen 1604, a user that selects running may be prompted to enter the duration, the level of exertion during the activity, the distance of the run, and the calories burned. Some additional examples of exercises that the output tracker can track are illustrated in FIG. 17.

Terms, such as “width,” “height,” “depth,” “vertical,” “horizontal,” “top,” “bottom,” “upper,” “lower,” “inner,” “inwardly,” “outer” and “outwardly,” may be used to assist in describing the invention based on the orientation of the embodiments shown in the illustrations. The use of directional terms should not be interpreted to limit the invention any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A health monitoring system comprising:
an intake tracker for recording consumable product information;
an output tracker for recording activity information;
a personal monitor for monitoring one or more personal characteristics; and
a recommender for analyzing the recorded consumable product information, the recorded activity information, and the one or more personal characteristics and in response, providing at least one of a health assessment and a recommendation.

2. The health monitoring system of claim 1 wherein the personal monitor includes a body mass index sensor, wherein body mass index sensor readings are used to reconcile an expected body mass index in view of the recorded consumable product information and the recorded activity information, wherein the at least one of the health assessment and the recommendation are adjusted in view of the reconciliation.

3. The health monitoring system of claim 1 wherein the personal monitor includes at least one of a glucose monitor and a metabolism sensor.

4. The health monitoring system of claim 1 wherein the intake tracker includes a camera for capturing images of products.

5. The health monitoring system of claim 1 including at least one of a Bluetooth interface, a WiFi interface, an IR transceiver interface, an Ethernet interface for facilitating communication with third party devices.

6. The health monitoring system of claim 1 including an interface to a social network.

7. The health monitoring system of claim 6 wherein information from at least one of the intake tracker, output tracker, and the personal monitor is shared in a personal health profile on the social network, and wherein access to the personal health profile is selectably restrictable.

8. The health monitoring system of claim 1 wherein the one or more personal characteristics include at least one of energy expended, respiration, heart rate, sleep state, and body temperature.

9. A method of monitoring health comprising:
recording product information with an intake tracker;
recording activity information with an output tracker;
monitoring one or more personal characteristics with a personal monitor; and
analyzing the recorded product information, the recorded activity information, and the personal characteristics;
providing, based on the analyzing, at least one of a health assessment and a recommendation.

10. The method of monitoring health of claim 9 wherein the monitoring includes monitoring body mass index and reconciling the monitored body mass index with an expected body mass index in view of the recorded consumable product information and the recorded activity information, wherein the at least one of the health assessment and the recommendation are adjusted in view of the reconciliation.

11. The method of monitoring health of claim 9 wherein the monitoring includes monitoring at least one of blood sugar and metabolism.

12. The method of monitoring health of claim 9 wherein the intake tracker includes a camera and recording product information includes capturing images of products with the camera.

13. The method of monitoring health of claim 9 wherein at least one of a Bluetooth interface, a WiFi interface, an IR transceiver interface, and an Ethernet interface are used for facilitating communication with a third party device in order to at least one of record product information, record activity information, and monitor one or more personal characteristics.

14. The method of monitoring health of claim 9 including interfacing a social network.

15. The method of monitoring health of claim 14 wherein at least one of the consumed products, activities, and the one or more personal characteristics are shared in a personal health profile, and wherein access to the personal health profile is selectably restrictable.

16. A health monitoring system comprising:
a camera for acquiring an image of a product;
a data acquisition system for acquiring nutritional information about the product based on the image of the product. a database for storing the image of the product and the associated nutritional information.

17. The health monitoring system of claim 16 wherein the image of the product includes at least one of an image of a food item, an image of a food package, and an image of a portion of a food package.

18. The health monitoring system of claim 16 wherein the data acquisition system includes a processor capable of optical character recognition of an image of a nutritional label of the product for acquiring the nutritional information about the product.

19. The health monitoring system of claim 18 wherein the data acquisition system includes a processor capable of comparing the image of the product to the database of product images and associated nutritional information, whereby the optical character recognition of the nutritional label provides a back-up data acquisition system when the product cannot be identified using the image comparison to the database of product images and associated with nutritional information.

20. The health monitoring system of claim 16 wherein the data acquisition system includes:
a first web crawler programmed to identify the product using the image of the product; and
a second web crawler programmed to identify nutritional information about the product using the product identity obtained by the first web crawler.

21. The health monitoring system of claim 16 wherein the data acquisition system determines the identity of the product from the image of the product and uses a look-up table to determine the nutrient components of the product based on the identity of the product.

22. A method of monitoring health comprising:
acquiring an image of a product with a camera;
acquiring nutritional information about the product based on the image of the product;
entering the acquired nutritional information and the image of the product into a database.

23. The method of monitoring health of claim 22 wherein the image of the product includes at least one of an image of a food item, an image of a food package, and an image of a portion of a food package.

24. The method of monitoring health of claim 22 wherein the acquiring nutritional information about the product based on the image of the product includes using optical character recognition on the image of the product where the image of the product includes a nutritional label of the product, wherein nutritional information from the optical character recognition of the nutritional label is associated with the product.

25. The method of monitoring health of claim 24 wherein acquiring information about the product includes comparing the image of the product to the database of product images associated with nutritional information, whereby using the optical character recognition of the nutritional label provides a back-up when comparing the product image to the database of product images associated with nutritional information is unsuccessful.

26. The method of monitoring health of claim 22 wherein the data acquisition system includes:
web crawling to identify the product using the image of the product; and
web crawling to identify nutritional information about the product using the product identity obtained by the web crawling to identify the product.

27. The method of monitoring health of claim 22 including determining the identity of the product from the image of the product and using a look-up table to determine the nutrient components of the product based on the identity of the product.

28. The method of monitoring health of claim 22 including user-assisted segmenting of the image.

29. The method of monitoring health of claim 28 wherein the user-assisted segmenting includes:
displaying the image of the product on a touch screen;
applying a segmentation algorithm that segments the image by creating a boundary;
dragging the boundary on the touch screen across a food item in the image of the product in order to assist the segmentation algorithm by indicating an amount of acceptable variation in appearance for the food item so that the segmentation algorithm dynamically changes the region around the boundary.
